(19) United States
(12) Patent Application Publication
(10) Pub. No.: US 2016/0258447 A1
(43) Pub. Date: Sep. 8, 2016

(54) NOISE ATTENUATION DEVICE FOR COMPRESSOR INLET DUCT

(71) Applicant: BORGWARNER INC., Auburn Hills, MI (US)

(72) Inventors: Andrew DAY, Huddersfield (GB); James MAWER, Franklin Square, Harrogate (GB); Andrew RICHARDSON, Dalton, Huddersfield (GB); Sanjit CHAGGAR, Bradford (GB); Steve BIRNIE, Halifax, Yorkshire (GB)

(21) Appl. No.: 15/032,172

(22) PCT Filed: Oct. 30, 2014
(86) PCT No.: PCT/US2014/063117

§ 371 Date: Apr. 26, 2016

Related U.S. Application Data
(60) Provisional application No. 61/897,964, filed on Oct. 31, 2013.

(51) Int. Cl. F04D 29/66; F04D 25/04; F04D 29/28; F02B 33/40; F04D 29/44; F01D 5/02; F01D 25/24; F02B 37/00; F04D 17/10; F04D 29/42

(52) U.S. Cl. CPC F04D 29/663; F04D 17/10; F04D 25/045; F04D 29/284; F04D 29/4206; F04D 29/441; F01D 5/02; F01D 25/24; F02B 37/00; F02B 33/40; F05D 2220/40

(57) ABSTRACT

A turbocharger compressor noise attenuation device (60, 160) is formed separately from the air inlet (16) of the compressor housing (12). The device (60) includes a tapered inner surface (66) having a minimum diameter portion (62) that is axially spaced apart from a first end face (50), a maximum diameter portion (64) that is between the minimum diameter portion (62) an opposed second end (48), and an annular groove (72) formed in a working face (74) of the minimum diameter portion that is parallel to the first end face (50).

### CROSS-REFERENCE TO RELATED APPLICATION

This application claims priority to and all benefits of U.S. Provisional Application No. 61/897,964, filed on Oct. 31, 2013, and entitled “Noise Attenuation Device For Compressor Inlet Duct”.

### FIELD OF THE INVENTION

The invention relates to a turbocharger with an improved compressor and more particularly, to a compressor inlet duct including a noise attenuation device.

### BACKGROUND OF THE INVENTION

Turbochargers are provided on an engine to deliver air to the engine intake at a greater density than would be possible in a normal aspirated configuration. This allows more fuel to be combusted, thus boosting the engine's horsepower without significantly increasing engine weight.

Generally, turbochargers use the exhaust flow from the engine exhaust manifold, which enters the turbine housing at a turbine inlet, to thereby drive a turbine wheel, which is located in the turbine housing. The turbine wheel is affixed to one end of a shaft, wherein the shaft drives a compressor wheel mounted on the other end of the shaft. As such, the turbine wheel provides rotational power to drive the compressor wheel and thereby drive the compressor of the turbocharger. This compressed air is then provided to the engine intake as described above.

The compressor stage of the turbocharger comprises the compressor wheel and its associated compressor housing. Filtered air is drawn axially into a compressor air inlet which defines a passage extending axially to the compressor wheel. Rotation of the compressor wheel forces pressurized air flow radially outwardly from the compressor wheel into the compressor volute for subsequent pressurization and flow to the engine.

### SUMMARY

In some aspects, an air intake pipe is configured to connect a turbocharger compressor air inlet to an air intake system of an engine. The air intake pipe includes an outer surface, an inner surface; a first end configured to connect to the air intake system, and a second end opposed to the first end. The second end includes an annular terminal end face corresponding to the surface extending between the outer surface and the inner surface, and a tapered portion protruding radially inward from the inner surface and disposed adjacent to the terminal end face. The tapered portion includes a minimum diameter portion that is axially spaced apart from the end face, a maximum diameter portion that is between the minimum diameter portion and the first end, and an annular groove formed in a working face of the minimum diameter portion that is parallel to the terminal end face, the groove extending about a circumference of the inner surface.

The air intake pipe may include one or more of the following features: The maximum diameter portion has a diameter that is less than that of the inner surface, whereby a first shoulder is defined at one end of the tapered portion. The maximum diameter portion has a diameter that is less than that of the inner surface, whereby a first shoulder is defined at one end of the tapered portion, the first shoulder facing the pipe first end, and the minimum diameter portion has a diameter that is less than that of the maximum diameter portion whereby a second shoulder corresponding to the working face is defined at another end of the tapered portion, the second shoulder facing the pipe second end and having a larger radial dimension than the first shoulder. The annular groove is shaped and dimensioned to receive an end of the air inlet in a press fit relationship. The tapered portion inner surface defines an angle relative to a longitudinal axis of the pipe, and the angle is in a range of 5 degrees to 75 degrees. The tapered portion inner surface defines an angle relative to a longitudinal axis of the pipe, and the angle is 15 degrees. The minimum diameter of the tapered portion is made to correspond to the minimum diameter of the turbocharger compressor air inlet. In some embodiments, the tapered portion inner surface has a linear profile. In other embodiments, the tapered portion inner surface has a non-linear profile.

In some aspects, a noise attenuation device is configured to be inserted between an air intake pipe and an air inlet of a turbocharger compressor. The noise attenuation device includes a hollow cylindrical body having a tapered inner surface and a tapered outer surface. The tapered inner surface includes one end corresponding to a minimum diameter portion of the tapered inner surface, and another end opposed to the one end and corresponding to a maximum diameter portion of the tapered inner surface. The outer surface includes an outwardly-protruding, circumferentially-extending first flange. The noise attenuation device is configured to be disposed coaxially within the air inlet in a manner such that the minimum diameter portion is downstream with respect to direction of air flow through the air inlet relative to the maximum diameter portion, and the first flange engages a corresponding groove formed on an inner surface of the air inlet at a location spaced apart from an inlet end of the air inlet, whereby the body is secured within the air inlet.

The noise attenuation device may include one or more of the following features: The outer surface of the insert further comprises a second flange disposed at an end corresponding to the maximum diameter portion, the second flange protruding radially outward so as to define a shoulder that is spaced apart from first end, and having a radial dimension corresponding to the thickness of a terminal end of the air inlet, such that when the insert is disposed the air inlet, the shoulder abuts the terminal end of the air inlet and the first flange resides within the groove. The noise attenuation device is formed of an elastic material. The noise attenuation device is formed of rubber. The outer surface further comprises an outwardly protruding, circumferentially extending second flange disposed at an end of the noise attenuation device corresponding to the maximum diameter portion. The second flange has a radial depth corresponding to a radial dimension of a wall of the air inlet. The tapered inner surface defines an angle relative to a longitudinal axis of the body, and the angle is in a range of 5 degrees to 75 degrees. The tapered inner surface defines an angle relative to a longitudinal axis of the body, and the angle is 15 degrees. In some embodiments, the tapered inner surface has a linear profile. In other embodiments, the tapered inner surface has a non-linear profile. The minimum diameter portion has a diameter that is less than the noise attenuation device outer diameter, whereby a shoulder is defined at the end corresponding to the minimum diameter portion which serves as a noise reflecting surface. The shoulder is configured so that when the noise attenuation device is inserted between an air intake pipe and an air inlet of a turbocharger compressor, the shoulder defines a working face that confronts an air vent passageway formed in the air inlet.

In some aspects, a compressor includes a compressor housing defining a cylindrical air inlet; a compressor wheel disposed within the housing adjacent to the air inlet; and an air intake pipe connected to the air inlet. The air intake pipe includes a first end, a second end opposed to the first end, the second end connected to the air inlet; a longitudinal axis extending between the first end and the second end; and a noise attenuation device protruding inward from, and extending circumferentially about, an inner surface of the air intake pipe adjacent the second end. The noise attenuation device is tapered along an axial direction of the air intake pipe such that a minimum diameter portion of the noise attenuation device is disposed at the second end.

The compressor includes one or more of the following features: The noise attenuation device includes a circumferential groove that receives a terminal end of the air inlet. The groove opens facing the compressor wheel, and is shaped and dimensioned to receive an end of the air inlet in a press fit relationship. A maximum diameter portion of the noise attenuation device is located between the minimum diameter portion and the first end. The noise attenuation device is formed integrally with the air intake pipe. The noise attenuation device is formed as an insert that is configured to be separable from, and received within, the air inlet. The insert includes an outer surface that includes an outwardly-protruding, circumferentially-extending first flange that is configured to be received in a corresponding groove formed on an inner surface of the air inlet, such that when the first flange is engaged with the groove, the insert is secured within the air inlet. The outer surface of the insert further comprises a second flange disposed at one end, the flange protruding radially outward so as to define a shoulder that is spaced apart from the one end and has a radial dimension corresponding to the thickness of a terminal end of the air inlet, such that when the insert is disposed the air inlet, the shoulder abuts the terminal end of the air inlet and the first flange resides within the groove.

In some aspects, an exhaust gas turbocharger includes a turbine including a turbine housing defining an exhaust gas inlet and a turbine wheel disposed in the turbine housing; a shaft rotatably supported on a bearing housing and having a first end connected to the turbine wheel; and the compressor described above, wherein the compressor wheel is connected to a second end of the shaft.

The air inlet of a turbocharger compressor sometimes includes a recirculation slot, which is a circumferential groove that surrounds the compressor wheel and serves to widen the pressure versus mass flow map that characterizes the compressor behavior, whereby the turbocharger becomes effective over a wider range of operating conditions. However, due the presence of the recirculation slot, noise can be generated that flows upstream in the direction of the engine air intake system, resulting in undesired noise in the air intake system.

A noise attenuation device for use in a turbocharger compressor is formed separately from the air inlet of the compressor housing. For example, the noise attenuation device may be formed at an outlet end of an air intake pipe, whereby by the noise attenuation device is properly positioned in the compressor air inlet when the air intake pipe is connected to the air inlet. In another example, the noise attenuation device may be formed as an insert that is inserted into the compressor air inlet before assembly of the air intake pipe with the compressor air inlet.

Advantageously, forming the noise attenuation device as part of an air intake pipe or as a separate insert is easier and less expensive than forming the noise attenuation device by casting the compressor housing with the noise attenuation device included as part of the air inlet. This is because the noise attenuation device provides an inwardly-tapered conical surface located at the inlet to the compressor wheel, a configuration that results in a relatively complex casting geometry that makes the removal of core sand very difficult. Similarly, the relatively complex casting geometry also makes it very difficult to remove swarf from the finished component. In additional to being difficult to cast, a full inspection of the cast components may be required to guarantee that all core sand and swarf have been removed, adding to the overall manufacturing cost. This can be compared to forming the noise attenuation device separately from the compressor housing, whereby manufacture of the noise attenuation device is simplified and materials used to form the noise attenuation device may be relatively inexpensive. Other objects and purposes of the invention, and variations thereof, will be apparent upon reading the following specification and inspecting the accompanying drawings.

### BRIEF DESCRIPTION OF THE DRAWINGS

FIG. 1 is a partially cut-away perspective view of an exhaust gas turbocharger.

FIG. 2 is perspective view of a compressor isolated from the turbocharger including an air intake pipe connected to the compressor air inlet, where the air intake pipe is illustrated as transparent to allow visualization of the interconnection between the noise attenuation device of the air intake pipe and the compressor air inlet.

FIG. 3 is a side cross-sectional view of the compressor and air intake pipe of FIG. 2.

FIG. 4 is a perspective cross-sectional view of an end of the air intake pipe of FIG. 2 including the noise attenuation device.

FIG. 5 is a side cross-sectional view of the air intake pipe of FIG. 4.

FIG. 6 is perspective view of a compressor isolated from the turbocharger including a noise attenuation device inserted in an air inlet of the compressor, and an air intake pipe connected to the compressor air inlet about the insert, where the air intake pipe is illustrated as transparent to allow visualization of the interconnection between the noise attenuation device, the air intake pipe and the compressor air inlet.

FIG. 7 is a side cross-sectional view of the compressor, noise attenuation device and air intake pipe of FIG. 6.

FIG. 8 is an enlarged partial view of the connection between the compressor and noise attenuation device corresponding to the circle region of FIG. 7.

FIG. 9 is a perspective view of an isolated noise attenuation device of FIG. 6.

FIG. 10 is a perspective cross-sectional view of the noise attenuation device of FIG. 6.

FIG. 11 is a side cross-sectional view of the noise attenuation device of FIG. 6.

### DETAILED DESCRIPTION

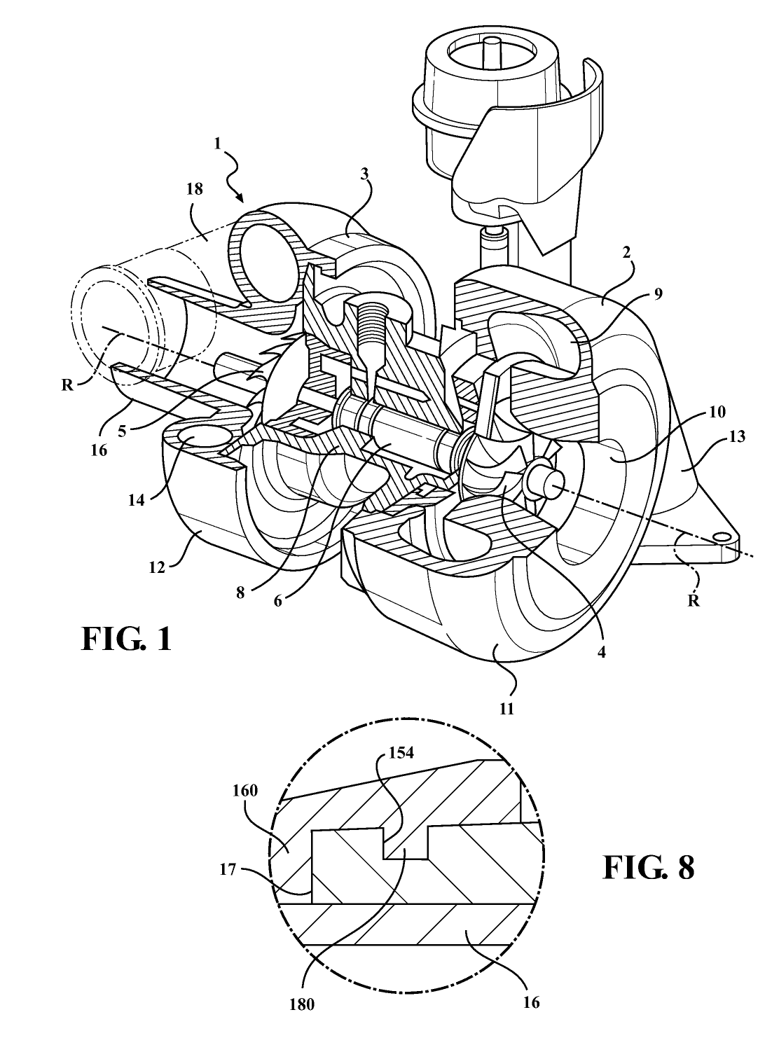

Referring to FIG. 1, an exhaust gas turbocharger 1 includes a turbine section 2, a compressor section 3, and a center bearing housing 8 disposed between and connecting the compressor section 3 to the turbine section 2. The turbine section 2 includes a turbine housing 11 that defines an exhaust gas inlet 13, an exhaust gas outlet 10, and a turbine volute 9 disposed in the fluid path between the exhaust gas inlet 13 and exhaust gas outlet 10. A turbine wheel 4 is disposed in the turbine housing 11 between the turbine volute 9 and the exhaust gas outlet 10. A drive shaft 6 is connected to the turbine wheel 4, is rotatably supported within in the bearing housing 8, and extends into the compressor 3. The compressor section 3 includes a compressor housing 12 that defines an air inlet 16, an air outlet 18, and a compressor volute 14. A compressor wheel 5 is disposed in the compressor housing 12 between the air inlet 16 and the compressor volute 14. The compressor wheel 5 is connected to, and driven by, the drive shaft 6.

In use, the turbine wheel 4 in the turbine housing 11 is rotatably driven by an inflow of exhaust gas supplied from the exhaust manifold of an engine. Since the drive shaft 6 is rotatably supported in the center bearing housing 8 and connects the turbine wheel 4 to the compressor wheel 5 in the compressor housing 12, the rotation of the turbine wheel 4 causes rotation of the compressor wheel 5. As the compressor wheel 5 rotates, it increases the air mass flow rate, airflow density and air pressure delivered to the engine's cylinders via an outflow from the compressor air outlet 18, which is connected to the engine's air intake manifold (not shown).

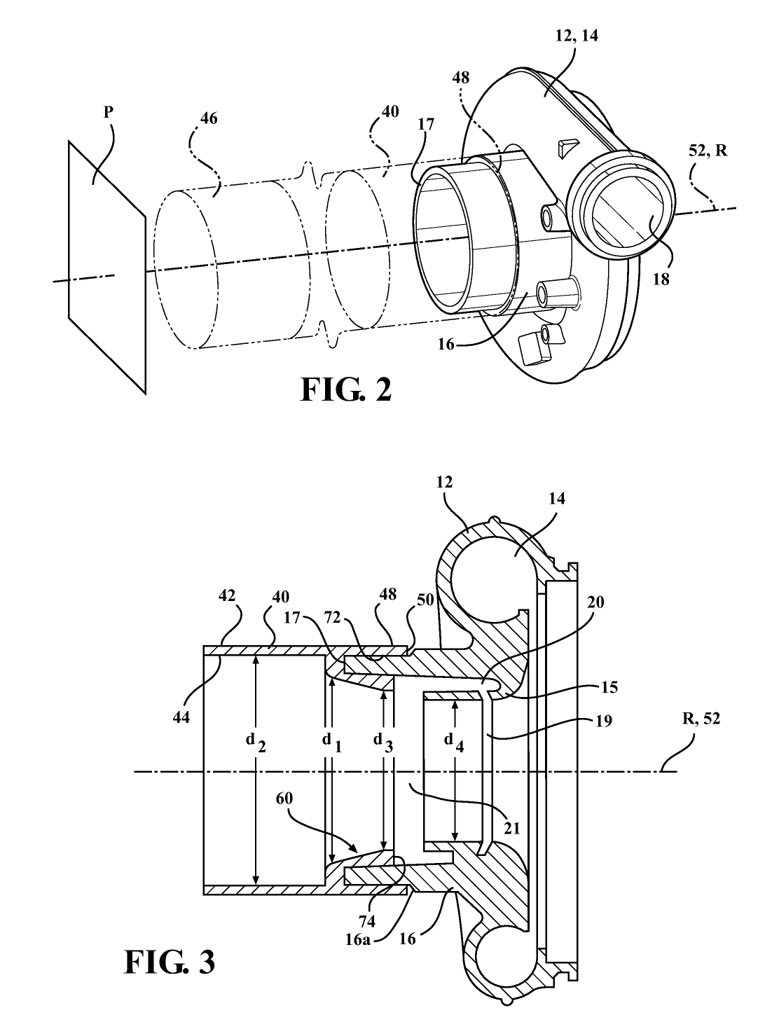

Referring to FIGS. 2 and 3, the air inlet 16 is a hollow, cylindrical member that extends coaxially with the rotational axis R of the drive shaft 6. An inner end 15 of the air inlet 16 is surrounded by the compressor volute 14, and the air inlet 16 protrudes from the compressor volute 14 so that an outer, terminal end 17 of the air inlet 16 is spaced apart from the compressor volute 14 along the rotational axis R. An inner surface of the air inlet 16 includes a circumferentially-extending air recirculation slot 19 that surrounds the compressor wheel 5 (not shown in FIG. 3 for clarity). An axially extending passage 20 formed in the compressor housing 12 connects the air recirculation slot 19 to a circumferentially-extending vent slot 21 positioned upstream of the air recirculation slot 19 relative to the direction of air flow (indicated by an arrow in FIG. 3) into the compressor air inlet 16. The air recirculation slot 19 relieves air pressure at the compressor wheel 5 by permitting a portion of air to be redirected away from the compressor wheel 5 via the passageway 20 and vent slot 21.

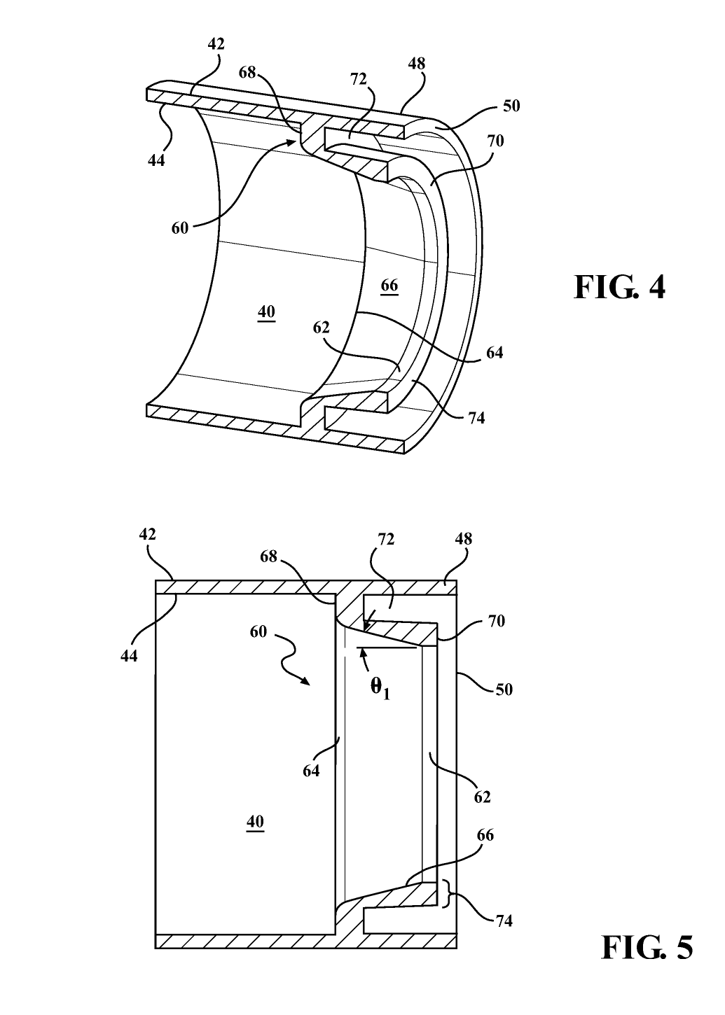

Referring to FIGS. 2-5, an air intake pipe 40 is configured to be connected to the air inlet terminal end 17, and is used to deliver air to the compressor from, for example, a vehicle air intake system (not shown). The air intake pipe 40 is an elongated, hollow cylindrical member that includes an outer surface 42, an inner surface 44, a first end 46 that is configured to be connected to the air intake system, and a second end 48 opposed to the first end 46. The second end 48 includes an annular terminal end face 50 corresponding to the surface extending between the outer surface 42 and the inner surface 44. The terminal end face 50 is generally parallel to a plane P transverse to a longitudinal axis 52 of the air intake pipe 40. In addition, the second end 48 includes a noise attenuation device 60. The noise attenuation device 60 is formed integrally with the air intake pipe 40, and is a broad ridge that protrudes radially inward from the pipe inner surface 44 and extends circumferentially about the pipe inner surface 44. The noise attenuation device 60 is disposed adjacent to the terminal end face 50, and includes a tapered inner surface 66 that extends axially between a minimum diameter portion 62 and a maximum diameter portion 64 that is spaced apart from the minimum diameter portion 62 along the longitudinal axis 52. The inner surface 66 defines an angle θ₁ relative to the pipe longitudinal axis 52. The angled inner surface 66 serves to smoothly direct air into the compressor wheel 5, thus reducing losses. The angle θ₁ may be in a range of 0 degrees to 89 degrees, and typically is in a range of 5 degrees to 75 degrees. In the illustrated embodiment, the angle θ₁ is 15 degrees.

In addition, the minimum diameter portion 62 is axially spaced apart from the terminal end face 50, and the maximum diameter portion 64 is located between the minimum diameter portion 62 and the pipe first end 46. The maximum diameter portion 64 has a diameter d1 that is less than a diameter d2 of the air intake pipe inner surface 44, whereby a first shoulder 68 is defined at the maximum diameter end of the noise attenuation device 60. The first shoulder 68 faces the pipe first end 46, is generally parallel to the plane P, and thus is also generally parallel to the pipe terminal end face 50. The minimum diameter portion 62 has a diameter d3 that is less than the diameter d1 of the maximum diameter portion 64, whereby a second shoulder 70 is defined at the minimum diameter end of the noise attenuation device 60. The second shoulder 70 has a radial dimension that is greater than that of the first shoulder 68, faces the pipe second end 48, and is generally parallel to the plane P.

An annular groove 72 is formed in the second shoulder 70, and extends about a circumference of the inner surface. The annular groove 72 is shaped and dimensioned to receive the terminal end 17 of the compressor air inlet 16, for example in a press fit relationship. As best seen in FIG. 3, when the inlet terminal end 17 is fully inserted into the groove 72, the pipe terminal end face 50 abuts a corresponding shoulder 16a formed in the outer surface of the air inlet 16.

Typically, to maximize noise attenuation and minimize intake airflow disruption, the minimum diameter d3 of the tapered portion 60 is made to correspond to a minimum diameter d4 of the compressor air inlet 16. The second shoulder surface in the area between the inner diameter of the groove 70 and the diameter d3 of the minimum diameter portion 62 defines a “working face” 74 of the tapered portion 60. In particular, when the air intake pipe 40 is assembled on the compressor air inlet 16, the working face 74 is positioned along a leading edge of the vent slot 21 so as to face the axial passageway 20. As a result, the working face 74 confronts sound waves that emanate from the axial passageway, reflecting them toward the interior space of the compressor 3 and thus reducing compressor noise.

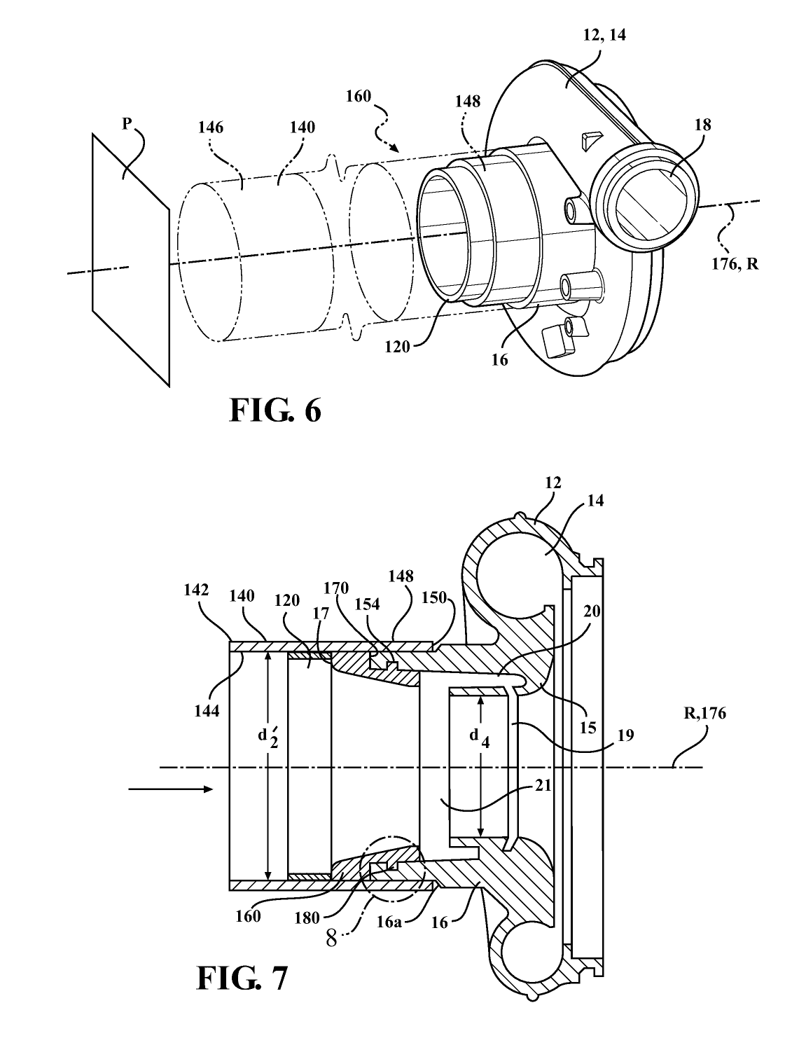

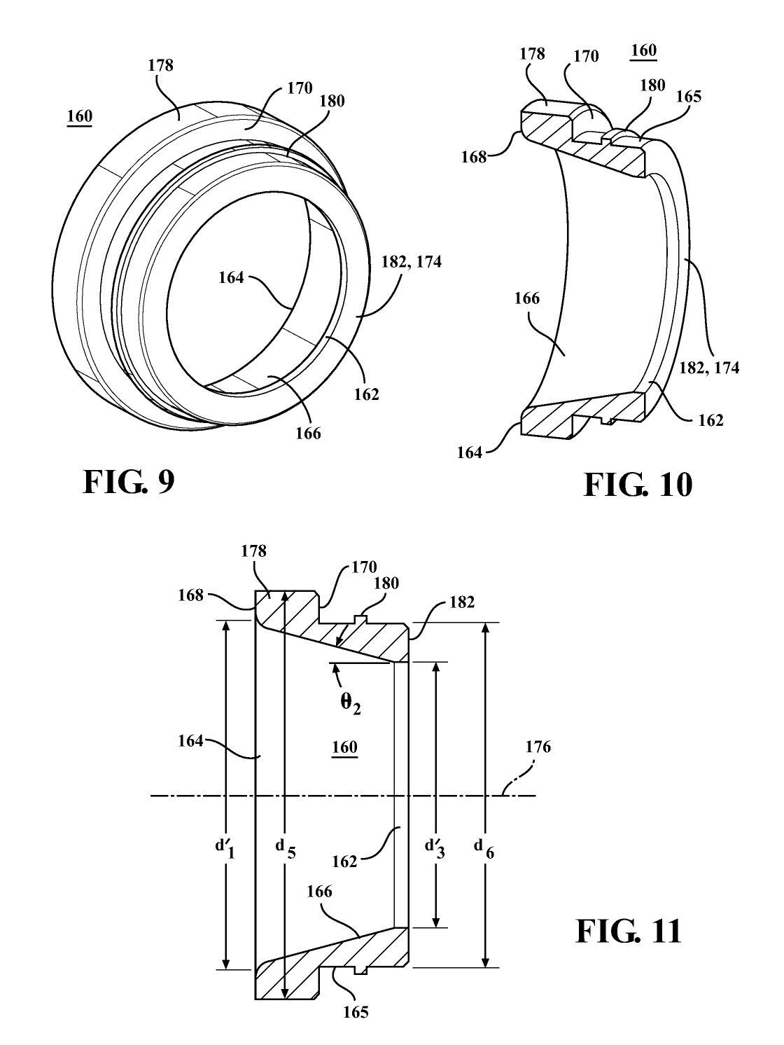

Referring to FIGS. 6-11, another embodiment noise attenuation device 160 is used to reduce turbocharger compressor noise. The noise attenuation device 160 is an insert that is assembled on the air inlet terminal end 17 prior to assembly of an air intake pipe 140 about an outer surface of the compressor air inlet 16, as discussed further below.

Referring to FIGS. 6 and 7, the air intake pipe 140 is configured to be connected to the air inlet terminal end 17, and is used to deliver air to the compressor from, for example, a vehicle air intake system (not shown). Like air intake pipe 40, the air intake pipe 140 is an elongated, hollow cylindrical member that includes an outer surface 142, an inner surface 144, a first end 146 that is configured to be connected to the air intake system, and a second end 148 opposed to the first end 146. The second end 148 includes an annular terminal end face 150 corresponding to the surface extending between the outer surface 142 and the inner surface 144. In use, the second end 148 receives the air inlet terminal end 17 therein, and the intake pipe terminal end face 150 abuts the shoulder 16a formed in the outer surface of the air inlet 16. Unlike the second end 48 of air intake pipe 40, the second end 148 of the air intake pipe 140 has a generally uniform inner diameter d2′.

Referring to FIGS. 7-11, the noise attenuation device 160 is formed independently (e.g., as a separate entity) from the air intake pipe 140 and the compressor inlet 16, and is a generally hollow cylindrical member having an outer surface 165 and a tapered inner surface 166. The inner surface 166 extends axially between a minimum diameter portion 162 and a maximum diameter portion 164 that is spaced apart from the minimum diameter portion 62 along a device longitudinal axis 176. The inner surface 166 defines an angle θ₂ relative to the device longitudinal axis 176. The angled inner surface 166 serves to smoothly direct air into the compressor wheel 5, thus reducing losses. The angle θ₂ may be in a range of 0 degrees to 89 degrees, and typically is in a range of 5 degrees to 75 degrees. In the illustrated embodiment, the angle θ₂ is 15 degrees.

A first radially outwardly-protruding, circumferentially-extending flange 178 is disposed on the air intake pipe outer surface 165 at an end corresponding to the maximum diameter portion 164. The first flange 178 has an outer diameter d5 that corresponds to the inner diameter d2′ of the air intake pipe second end 148. The first flange outer diameter d5 is greater than a diameter d1′ of the maximum diameter portion, whereby a first shoulder 168 is defined at the maximum diameter end of the noise attenuation device 160. The first shoulder 168 is generally perpendicular to a plane P transverse to the longitudinal axis 176. In addition, the first flange outer diameter d5 is greater than the outer diameter d6 of the noise attenuation device outer surface 165, whereby a second shoulder 170 is defined on an axially-opposed end of the first flange 178 relative to the first shoulder 168. The minimum diameter portion 162 has a diameter d3′ that is less than the noise attenuation device outer diameter d6, whereby a third shoulder 182 is defined at the minimum diameter end of the noise attenuation device 160. The third shoulder 182 is generally parallel to the transverse plane P.

A second radially outwardly-protruding, circumferentially-extending flange 180 is disposed on the air intake pipe outer surface 165 between the first flange 178 and the minimum diameter portion 162. The second flange 180 has axial and radial dimensions that are smaller than that of the first flange 178, and is configured to be received in a corresponding groove 154 formed on an inner surface of the air inlet 16 at a location spaced apart from the air inlet terminal end 17.

When the noise attenuation device 160 is assembled with the compressor inlet 16, the noise attenuation device 160 is oriented so that the minimum diameter portion 162 is downstream with respect to direction of air flow (indicated by an arrow in FIG. 7) through the compressor air inlet 16 relative to the maximum diameter portion 164. In addition, the minimum diameter portion 162 is inserted into the air inlet 16 to an extent that the second shoulder 170 abuts the air inlet terminal end 17 and the second flange 180 is disposed in the air intake groove 154 whereby the noise attenuation device 160 is axially secured within the air inlet 16. In this configuration, the maximum diameter portion 164 is located outside the compressor air inlet 16 at a location that is axially spaced apart from the inlet terminal end 17, the first shoulder 168 faces away from the air inlet terminal end 17 and the third shoulder 182 faces the compressor housing axial passageway 20.

After the noise attenuation device is assembled with the compressor inlet 16, the air intake pipe 140 is assembled with the compressor inlet 16. In particular, the air intake pipe second end 148 is moved axially in the direction of air flow into the compressor 3 (indicated by an arrow in FIG. 7), so that the noise attenuation device 160 and air inlet terminal end 17 are received inside the pipe second end 148. In the assembled configuration, the minimum diameter portion 162 is axially spaced apart from the intake pipe terminal end face 150, and a radially-outward facing surface of the first flange 178 faces the intake pipe inner surface 144.

In order to maximize noise attenuation and minimize intake airflow disruption, the diameter d3′ of the minimum diameter portion 162 is made to correspond to a minimum diameter d4 of the compressor air inlet 16. The third shoulder surface defines a “working face” 174 of the noise attenuation device 160. When the noise attenuation device 160 is assembled on the compressor air inlet 16, the working face 174 is positioned along a leading edge of the vent slot 21 so as to face the axial passageway 20. As a result, the working face 174 confronts sound waves that emanate from the axial passageway, reflecting them toward the interior space of the compressor 3 whereby compressor noise is reduced.

In some embodiments, the noise attenuation device 160 is formed of an elastic material. For example, the noise attenuation device 160 may be formed of molded rubber. Using an elastic material is advantageous relative to using metal since an elastic material facilitates assembly and function of the noise attenuation device 160. For example, a rubber noise attenuation device may have sufficient elasticity to permit deflection and/or compression of the second flange 180 thereby facilitating insertion of the device 160 into the air inlet 16 and sufficient resilience so that the second flange regains its radially upstanding orientation within the groove 154. While having some flexibility and resilience, the rubber noise attenuation device may also have sufficient stiffness so that the second flange serves to retain the axial position of the noise attenuation device 160 relative to the air inlet 16. In addition, any movement of the rubber noise attenuation device within the air inlet 16 during operation (for example due to engine or turbocharger vibration) would be relatively quiet compared to a noise attenuation device that was formed of metal.

In some embodiments, an annular retaining ring 120 is disposed within the air intake pipe 140 abutting the first shoulder 168. The retaining ring 120 has an outer diameter that corresponds to the air intake pipe inner diameter d2′, and helps to maintain the noise attenuation device 160 in the desired position relative to the air inlet 16. In the illustrated embodiment, the retaining ring is formed separately from the intake pipe 140, and is assembled with the air intake pipe 140 prior to assembly of the air intake pipe 140 with the compressor air inlet 16. The retaining ring 120 may be secured to the pipe inner surface 144 using an adhesive, and/or the pipe inner surface 144 may include surface features (not shown) that retain the annular ring 120 in the desired axial location, including ridges or grooves. In other embodiments, the retaining ring 120 may be formed integrally with the intake pipe inner surface 144. In still other embodiments, the retaining ring 120 may be omitted.

Although the air intake pipe 40, 140 is described herein as being cylindrical, it is not limited to this cross sectional shape. The cross-sectional shape of the air intake pipe is generally matched to the cross-sectional shape of the compressor air inlet, and/or may have a polygonal or irregular curved cross-sectional shape.

The noise attenuation device 60, 160 includes the tapered inner surface 66, 166 that extends linearly between the minimum diameter portion 62, 162 and the maximum diameter portion 64, 164. However, the inner surface 66, 166 is not limited to a linear configuration, and instead may have a curved and/or non-linear profile.

Although particular preferred embodiments of the invention have been disclosed in detail for illustrative purposes, it will be recognized that variations or modifications of the disclosed apparatus, including the rearrangement of parts, lie within the scope of the present invention.

We claim:

1. An air intake pipe (40) configured to connect a turbocharger compressor air inlet (16) to an air intake system of an engine, the air intake pipe (40) comprising;
an outer surface (42),
an inner surface (44);
a first end (46) configured to connect to the air intake system, and
a second end (48) opposed to the first end (46), the second end (48) including
an annular terminal end face (50) corresponding to the surface extending between the outer surface (42) and the inner surface (44), and
a tapered portion (60) protruding radially inward from the inner surface (44) and disposed adjacent to the terminal end face (50), the tapered portion including
a minimum diameter portion (62) that is axially spaced apart from the end face (50),
a maximum diameter portion (64) that is between the minimum diameter portion and the first end (46), and
an annular groove (72) formed in a working face (74) of the minimum diameter portion (62) that is parallel to the terminal end face (50), the groove (72) extending about a circumference of the inner surface (44).

2. The air intake pipe (40) of claim 1, wherein the maximum diameter portion (64) has a diameter that is less than that of the inner surface (44), whereby a first shoulder (68) is defined at one end of the tapered portion (60).

3. The air intake pipe (40) of claim 1, wherein
the maximum diameter portion (64) has a diameter that is less than that of the inner surface (44), whereby a first shoulder (68) is defined at one end of the tapered portion (60), the first shoulder facing the pipe first end (46), and
the minimum diameter portion (62) has a diameter (d3) that is less than that of the maximum diameter portion (64) whereby a second shoulder (70) corresponding to the working face (74) is defined at another end of the tapered portion, the second shoulder (70) facing the pipe second end (48) and having a larger radial dimension than the first shoulder (68).

4. The air intake pipe (40) of claim 1, wherein the annular groove (72) is shaped and dimensioned to receive an end (17) of the air inlet (16) in a press fit relationship.

5. The air intake pipe (40) of claim 1, wherein the minimum diameter of the tapered portion (60) is made to correspond to the minimum diameter of the turbocharger compressor air inlet (16).

6. A noise attenuation device (160) configured to be inserted between an air intake pipe (140) and an air inlet (16) of a turbocharger compressor (3), the noise attenuation device (160) comprising
a hollow cylindrical body including
a tapered inner surface (166),
one end corresponding to a minimum diameter portion (162) of the tapered inner surface (166),
another end opposed to the one end and corresponding to a maximum diameter portion (164) of the tapered inner surface (166), and
an outer surface (165) that includes
an outwardly-protruding, circumferentially-extending first flange (180),
wherein the noise attenuation device (160) is configured to be disposed coaxially within the air inlet (16) in a manner such that the minimum diameter portion (162) is downstream with respect to direction of air flow through the air inlet (16) relative to the maximum diameter portion (164), and the first flange (180) engages a corresponding groove (154) formed on an inner surface of the air inlet (16) at a location spaced apart from an inlet end (17) of the air inlet (16), whereby the body is secured within the air inlet (16).

7. The noise attenuation device (160) of claim 6, wherein the outer surface (158) further comprises a second flange (178) disposed at the another end corresponding to the maximum diameter portion (164), the second flange (178) protruding radially outward so as to define a shoulder (170) that is spaced apart from the another end, and having a radial dimension corresponding to the thickness of a terminal end (17) of the air inlet (16), such that when the insert is disposed the air inlet (16), the shoulder (170) abuts the terminal end (17) of the air inlet (16) and the first flange (180) resides within the groove (154).

8. The noise attenuation device (160) of claim 6 wherein the noise attenuation device (160) is formed of an elastic material.

9. The noise attenuation device (160) of claim 6 wherein the minimum diameter portion (162) has a diameter (d3′) that is less than the noise attenuation device outer diameter (d6), whereby a shoulder (182) is defined at the end corresponding to the minimum diameter portion (162) which serves as a noise reflecting surface.

10. The noise attenuation device (160) of claim 9, wherein the shoulder (182) is configured so that when the noise attenuation device is inserted between an air intake pipe (140) and an air inlet (16) of a turbocharger compressor (3), the shoulder (182) defines a working face (174) that confronts an air vent passageway (20) formed in the air inlet (16).

11. An exhaust gas turbocharger (1) comprising:
a turbine (2) including a turbine housing (11) and a turbine wheel (4) disposed in the turbine housing (11);
a compressor (3) including
a compressor housing (12) defining a cylindrical air inlet (16);
a compressor wheel (5) disposed within the compressor housing (12) adjacent to the air inlet (16), the compressor wheel (3) connected to the turbine wheel (4) via a shaft (6);
an air intake pipe (140) connected to the air inlet (16), the air intake pipe (140) comprising:
a first end (146);
a second end (148) opposed to the first end (146), the second end (148) connected to the air inlet (16);
a longitudinal axis (152) extending between the first end (146) and the second end (148); and
a noise attenuation device (160) protruding inward from, and extending circumferentially about, an inner surface (144) of the air intake pipe (140) adjacent the second end (148), wherein the noise attenuation device (160) is tapered along an axial direction of the air intake pipe (140) such that a minimum diameter portion (162) of the noise attenuation device (160) is disposed at the second end (148).

12. The exhaust gas turbocharger of claim 11, wherein the noise attenuation device (160) includes a circumferential groove (72) that receives a terminal end of the air inlet (16).

13. The exhaust gas turbocharger of claim 12 wherein the groove (72) opens facing the compressor wheel (5), and is shaped and dimensioned to receive an end of the air inlet (16) in a press fit relationship.

14. The exhaust gas turbocharger of claim 11 wherein the noise attenuation device (160) is formed as an insert that is configured to be separable from, and received within, the air inlet (16), the insert comprising:
an outer surface (142) that includes an outwardly-protruding, circumferentially-extending first flange (180) that is configured to be received in a corresponding groove (154) formed on an inner surface of the air inlet (16), such that when the first flange (180) is engaged with the groove (154), the insert is secured within the air inlet (16).

15. The exhaust gas turbocharger of claim 14, wherein the outer surface (142) of the insert further comprises a second flange (178) disposed at one end, the flange (178) protruding radially outward so as to define a shoulder that is spaced apart from the one end and has a radial dimension corresponding to the thickness of a terminal end (17) of the air inlet (16), such that when the insert is disposed the air inlet (16), the shoulder (178) abuts the terminal end of the air inlet (16) and the first flange (180) resides within the groove (154).
